(19) United States
(12) Patent Application Publication
(10) Pub. No.: US 2004/0198235 A1
(43) Pub. Date: Oct. 7, 2004

(54) Radio communication system, terminal station and base station of radio communication system, and transmission power control method of radio communication system

(76) Inventor: Hiroyasu Sano, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,192

(22) PCT Filed: Aug. 12, 2002
(86) PCT No.: PCT/JP02/08220

(30) Foreign Application Priority Data
Aug. 28, 2001 (JP) 2001-257157

(51) Int. Cl. H04B 1/00; H04B 7/00

(52) U.S. Cl. 455/69; 455/522

(57) ABSTRACT

A wireless communication system includes a terminal station and a plurality of base stations. The terminal station includes a received power measuring unit that measures a power of radio signals transmitted from the base stations, and a combined signal selector that selects a combined signal used for diversity combining, an interference signal suppression controller that generates a transmission power suppress command based on a received power difference between the combined signal and an interference signal not having been selected as the combined signal, and a transmission processor that outputs the command to the base stations. The base station suppresses the transmission power for the terminal station by a predetermined attenuation amount when receiving the command.

### TECHNICAL FIELD

The present invention relates to a wireless communication system for controlling transmission power of a radio signal transmitted from a base station to a terminal station according to reception quality of the terminal station. More particularly, the present invention relates to a wireless communication system in which a terminal station performs diversity combining on radio signals transmitted, with respective predetermined power, from a plurality of base stations, and also relates to a terminal station and a base station applied to the wireless communication system, and a transmission power control method for the wireless communication system.

### BACKGROUND ART

A mobile wireless communication system often employs a “site diversity system” in order to improve the quality of received signals in a terminal station. The site diversity system is realized by transmitting the same data from a plurality of base stations to one terminal station and receiving signals in the terminal station to combine the signals. The site diversity system requires “transmission power control” for controlling signal transmission power from the base stations, in order to reduce variations in the intensity of received signals transmitted from the base stations and improve demodulation capability of the signals in the terminal station.

FIG. 13 is a block diagram of a wireless communication system schematically illustrating transmission power control in a conventional site diversity system described, for example, in “Independent Fast Transmit Power Control for Each Cell Site in W-CDMA Forward Link Inter-cell Site Diversity” (Morimoto et al., The Institute of Electronics, Information and Communication Engineers, Technical Report of IEICE RCS2000-163, November, 2000). The conventional method of controlling transmission power is explained below with reference to FIG. 13.

Radio signals are multiplexed in the same frequency band based on a CDMA and transmitted from two base stations BS_1 and BS_2 to a demodulation processor 1 in a terminal station 100. A despreading process is discretely performed on each of the radio signals, and then the received signals are subjected to diversity combining to reproduce received data.

On the other hand, the radio signals multiplexed and transmitted from the base stations BS_1 and BS_2 are input in a plurality of received power measuring units 3 corresponding to the base stations BS_1 and BS_2 to which the terminal station 100 is connected. Each of the received power measuring units 3 calculates a received power for a corresponding base station.

The received powers for the base stations BS_1 and BS_2 are input in a target power controller 104. The target power controller 104 previously stores nominal values of the transmission power in the base stations BS_1 and BS_2, and compares the nominal value of the transmission power with the received power for each of the base stations BS_1 and BS_2 to calculate each propagation path loss of the received signals from the base stations BS_1 and BS_2.

The target power controller 104 determines each target value of the received power for the base stations BS_1 and BS_2 based on the respective propagation path losses of the base stations BS_1 and BS_2. The target power is set so that the target value of the received power from the base station having a small amount of propagation loss is increased and the target value of the received power from the base station having a large amount of propagation loss is decreased.

A plurality of transmission power command generators 105 corresponding to the base stations BS_1 and BS_2 compare each received power of a corresponding base station with a target received power of the base station, respectively. As a result, if the received power is less than the target received power, the transmission power command control generator 105 generates a transmission power control command that allows the base station to increase the transmission power. On the other hand, if the received power exceeds the target power, the transmission power control command generator 105 does not generate the transmission power control command.

The transmission power control commands respectively generated for the base stations BS_1 and BS_2 are demodulated and transmitted wirelessly from the terminal station 100 to the base stations BS_1 and BS_2. Each transmission power control command reading unit 6 of the base stations BS_1 and BS_2 extracts a transmission power control command targeted to each of the base stations out of the radio signals transmitted from the terminal station 100.

As a result, when the transmission power control command targeted to the base station is extracted, a transmission power controller 7 amplifies the transmission power of the radio signal for the terminal station 100 by a predetermined amplification amount (e.g.,+1 dB) that is set in advance.

On the other hand, when the transmission power control command targeted to the base station is not extracted within a predetermined period set in advance, the transmission power controller 7 attenuates the transmission power of the radio signal for the terminal station 100 by a predetermined attenuation amount (e.g., −1 dB) that is set in advance.

In the conventional wireless communication system, the terminal station 100 sets each target power of received signals in consideration of propagation path losses for the base stations BS_1 and BS_2, and performs transmission power control discretely for the base stations BS_1 and BS_2 to obtain a desired received power.

However, in a wireless communication system that covers a service area by spacing a large number of micro cells as base stations each having a radius of, for example, hundreds meters or less, the terminal station 100 receives signals from the base stations.

The transmission power of the base stations BS_1 and BS_2 each of which covers the micro cells is lower than the transmission power of a base station that covers wide-area cells (e.g., each having a radius of about several kilometers). Therefore, radio signals transmitted from the large number of base stations and received by the terminal station 100 include the considerable number of radio signals each of which has a value less than the received power at which the radio signal can be sufficiently demodulated.

Such a low-power received signal does not contribute to improvement of image quality in site diversity combining, and therefore, the signal cannot be used for demodulation process in the terminal station 100. Further, such a signal acts as an interference component during the demodulation process of a radio signal having a large received power, which causes degradation of demodulation capability.

In such a case, the conventional wireless communication system performs transmission power control so that the transmission power of a base station transmitting the low-power received signal is increased. In actual cases, however, the transmission power of the micro-cell base station has an upper limit, and therefore, the terminal station 100 may sometimes receive a signal with undesired power.

Moreover, if the wireless communication system continues to perform the transmission power control on a plurality of low-power received signals each having been decreased to such an extent that sufficient demodulation capability cannot be obtained in the terminal station 100, and uniformly amplifies the transmission power of the base stations, then this causes power consumption of the whole system to be increased.

Therefore, an object of the present invention is to realize transmission power control capable of reducing influence of interference by low-power received signals in consideration of propagation path loss of each base station, in a wireless communication system in which a terminal station 100 receives radio signals from a large number of base stations and performs site diversity combining on the received signals to obtain received data.

### DISCLOSURE OF THE INVENTION

A terminal station in a wireless communication system according to the present invention receives radio signals transmitted, with respective predetermined power, from a plurality of base stations and performs diversity combining on the radio signals. The terminal station includes a plurality of received power measuring units that measure each received power of radio signals transmitted from the base stations, and a combined signal selecting unit that selects a predetermined number of radio signals to be used for diversity combining as combined signals based on each result of measuring the received power of the radio signals. The terminal station also includes an interference signal suppression control unit that specifies another radio signal, as an interference signal, that has not been selected as the combined signal, calculates a received power difference between the interference signal and the combined signal, and generates a transmission power suppress command for instructing suppression of transmission power according to the received power difference, and a transmission processing unit that modulates the transmission power suppress command to be transmitted to a base station that transmits the interference signal.

In the terminal station according to next invention, the interference signal suppression control unit previously stores threshold values for a plurality of received power differences for classifying interference signals into a plurality of classes for power differences, compares each received power difference of the interference signal with the threshold values, classifies the received power difference into any of the classes, and generates a transmission power suppress command including a specific information series for specifying a classified class for the power difference.

In the terminal station according to next invention, the received power measuring unit measures a signal power-to-interference power ratio for a specific known series included in each of the radio signals instead of received powers of the radio signals, the combined signal selecting unit selects a combined signal based on each signal power-to-interference power ratio of the radio signals, and the interference signal suppression control unit calculates a difference between the signal power-to-interference power ratios of an interference signal and the combined signal, and generates a transmission power suppress command based on the difference.

In the terminal station according to next invention, the interference signal suppression control unit previously stores an attenuation-instructed threshold value as a threshold value of a received power difference for determining whether suppression of the transmission power is instructed, compares the received power difference of the interference signal with the attenuation-instructed threshold value, and generates a transmission power suppress command for instructing suppression of the transmission power of the interference signal when the received power difference is the attenuation-instructed threshold value or larger.

In the terminal station according to next invention, the interference signal suppression control unit specifies, as interference signals, another radio signals that have not been selected as the combined signal, calculates each received power difference between the interference signal and the combined signal, and generates a transmission power suppress command for instructing suppression of the transmission power according to the received power difference for each of the interference signals, and the transmission processing unit modulates the transmission power suppress command to be transmitted to base stations that transmit the interference signals.

A base station for a wireless communication system, according to next invention, in which a terminal station receives radio signals transmitted, with respective predetermined power, from a plurality of base stations and performs diversity combining on the radio signals, comprising a transmission power control unit that controls so as to suppress transmission power of a radio signal to be transmitted to the terminal station by a predetermined attenuation amount when a transmission power suppress command is transmitted from the terminal station to the base station.

In the base station according to next invention, the transmission power control unit extracts the transmission power suppress command targeted to the base station including a specific information series for specifying a class for the power difference of an interference signal determined by the terminal station based on a transmission power difference of the interference signal, and determines an attenuation amount of radio power to be transmitted to the terminal station based on the magnitude of the received power difference in the specified class.

In the base station according to next invention, the transmission power control unit previously stores a power-suppressed threshold value as a threshold value for a received power difference for determining whether transmission power is to be suppressed, and includes a command analyzer that issues an attenuation instructing signal that makes an attenuation amount of the transmission power decreased when a received power difference in the specified class is smaller than the power-suppressed threshold value, and that makes the attenuation amount of the transmission power increased when the received power difference is greater than the power-suppressed threshold value, and an attenuation amount determiner that integrates the attenuation instructing signals over a predetermined period of time, and calculates an attenuation amount of a radio signal to be transmitted to a terminal station according to the integrated value of the attenuation instructing signals.

In the base station according to next invention, the transmission power control unit further includes an averaging unit that sequentially inputs the attenuation amounts of the transmission power determined based on the transmission power suppress command, and calculates a moving average value of the attenuation amounts over a predetermined period of time, wherein the transmission power for a terminal station is suppressed according to an attenuation amount after the averaging is performed.

In the base station according to next invention, the transmission power control unit further includes a low-pass filter having a predetermined frequency characteristic, instead of the averaging unit, wherein the transmission power for a terminal station is suppressed according to an attenuation amount of the transmission power after filtering is performed.

In the base station according to next invention, the transmission power control unit further includes a command storage that stores transmission power suppress commands transmitted from the terminal station to the base station during a predetermined period of time, and an attenuation amount determiner that counts a total number of the stored transmission power suppress commands, and determines an attenuation amount of the transmission power of a radio signal to be transmitted to the terminal station based on the counted number.

A wireless communication system, according to next invention, in which a terminal station receives radio signals transmitted, with respective predetermined power, from a plurality of base stations and performs diversity combining on the radio signals, comprising the terminal station including a plurality of received power measuring units that measure each received power of radio signals transmitted from the base stations; a combined signal selecting unit that selects a predetermined number of radio signals used for diversity combining as combined signals, based on each result of measuring the received power of the radio signals; an interference signal suppression control unit that specifies another radio signal, as an interference signal, that has not been selected as the combined signal, calculates a received power difference between the interference signal and the combined signal, and generates a transmission power suppress command for instructing suppression of the transmission power according to the received power difference; and a transmission processing unit that modulates the transmission power suppress command to be transmitted to a base station that transmits the interference signal; and the base stations each including a transmission power control unit that controls so as to suppress the transmission power of a radio signal to be transmitted to the terminal station by a predetermined attenuation amount when the transmission power suppress command is transmitted from the terminal station to the base station, wherein each of the base stations suppresses the transmission power of a radio signal to be transmitted to the terminal station by a predetermined attenuation amount when the transmission power suppress command is transmitted from the terminal station to the base station.

In the wireless communication system according to next invention, the interference signal suppression control unit previously stores threshold values for a plurality of received power differences for classifying interference signals into a plurality of classes for power differences, compares a received power difference of each of the interference signals with the threshold values, classifies the received power difference into any of the classes, and generates a transmission power suppress command including a specific information series for specifying a classified class for the power difference.

In the wireless communication system according to next invention, the received power measuring unit measures a signal power-to-interference power ratio for a specific known series included in each of radio signals instead of received powers of the radio signals, the combined signal selecting unit selects a combined signal based on each signal power-to-interference power ratio of the radio signals, and the interference signal suppression control unit calculates a difference between the signal power-to-interference power ratios of the interference signal and the combined signal, and generates a transmission power suppress command based on the difference.

In the wireless communication system according to next invention, the interference signal suppression control unit specifies another radio signals, as interference signals, that have not been selected as a combined signal, calculates a received power difference between each of the interference signals and the combined signal, and generates a transmission power suppress command for instructing suppression of the transmission power according to the received power difference for each of the interference signals, and the transmission processing unit modulates the transmission power suppress command to be transmitted to base stations that transmit the interference signals.

In the wireless communication system according to next invention, the transmission power control unit extracts the transmission power suppress command targeted to the base station including a specific information series for specifying a class for a power difference of an interference signal determined by the terminal station based on a transmission power difference of the interference signal, and determines an attenuation amount of radio power to be transmitted to the terminal station based on the magnitude of the received power difference in the specified class.

In the wireless communication system according to next invention, the transmission power control unit previously stores a power-suppressed threshold value as a threshold value of a received power difference for determining whether the transmission power is to be suppressed, and includes a command analyzer that issues an attenuation instructing signal that makes an attenuation amount of transmission power decreased when a received power difference in the specified class is smaller than the power-suppressed threshold value, and that makes the attenuation amount of transmission power increased when the received power difference class is greater than the power-suppressed threshold value, and an attenuation amount determiner that integrates the attenuation instructing signals over a predetermined period of time, and calculates an attenuation amount of a radio signal to be transmitted to a terminal station according to an integrated value of the attenuation instructing signals.

In the wireless communication system according to next invention, the transmission power control unit further includes an averaging unit that sequentially inputs attenuation amounts of transmission power determined based on the transmission power suppress command, and calculates a moving average value of the attenuation amounts over a predetermined period of time, wherein the transmission power for a terminal station is suppressed according to an attenuation amount after the averaging is performed.

In the wireless communication system according to next invention, the transmission power control unit further includes a low-pass filter having a predetermined frequency characteristic, instead of the averaging unit, wherein the transmission power for a terminal station is suppressed according to an attenuation amount of the transmission power after filtering is performed.

In the wireless communication system according to next invention, the interference signal suppression control unit in the terminal station generates a specific information series having redundancy as a transmission power suppress command, and the transmission power control unit in each of the base stations previously stores the specific information series that has a likelihood of being transmitted from the terminal station, and calculates a correlation value between an information series actually transmitted from the terminal station and the previously stored information series to specify an information series with a maximum likelihood as the transmission power suppress command, based on the correlation value.

In the wireless communication system according to next invention, the interference signal suppression control unit previously stores an attenuation-instructed threshold value as a threshold value of a received power difference for determining whether a control for suppression of transmission power is instructed, compares a received power difference of the interference signal with the attenuation-instructed threshold value, and generates a transmission power suppress command for instructing suppression of the transmission power of the interference signal when the received power difference is the attenuation-instructed threshold value or larger, and the transmission power control unit includes a command storage that stores transmission power suppress commands transmitted from the terminal station to the base station during a predetermined period of time, and an attenuation amount determiner that counts a total number of the stored transmission power suppress commands, and determines an attenuation amount of the transmission power of a radio signal to be transmitted to the terminal station based on the counted number.

In the wireless communication system according to next invention, the interference signal suppression control unit specifies another radio signals, as interference signals, that have not been selected as the combined signal, calculates a received power difference between each of the interference signals and the combined signal, and generates a transmission power suppress command for instructing suppression of transmission power according to the received power difference for each of the interference signals, and the transmission processing unit modulates the transmission power suppress command to be transmitted to base stations that transmit the interference signals.

A transmission power control method, according to next invention, for a wireless communication system in which a terminal station receives radio signals transmitted, with respective predetermined power, from a plurality of base stations and performs diversity combining on the radio signals, comprising the steps of in the terminal station, measuring each received power of radio signals transmitted from the base stations; selecting a predetermined number of radio signals used for diversity combining as combined signals based on each result of measuring the received power of the radio signals; controlling suppression of an interference signal by specifying another radio signal, as an interference signal, that has not been selected as the combined signal, calculating a received power difference between the interference signal and the combined signal, and generating a transmission power suppress command for instructing suppression of the transmission power according to the received power difference; and modulating the transmission power suppress command to be transmitted to a base station that transmits an interference signal; and n each of the base stations, controlling transmission power of a radio signal to be transmitted to the terminal station by a predetermined attenuation amount when the transmission power suppress command is transmitted from the terminal stations to the base station.

In the transmission power control method according to next invention, the step of controlling suppression of the interference signal includes previously storing threshold values of a plurality of received power differences to classify interference signals into a plurality of classes for power differences; comparing a received power difference of the interference signal with the threshold values; classifying the received power difference into any of the classes; and generating a transmission power suppress command including a specific information series for specifying the classified class for the power difference, and the transmission power control step of the base stations includes determining an attenuation amount of the transmission power of a radio signal to be transmitted to the terminal station based on the information series specifying the class.

In the transmission power control method according to next invention, the step of controlling transmission power includes previously storing a power-suppressed threshold value as a threshold value of a received power difference for determining whether transmission power is to be suppressed; analyzing a command by issuing an attenuation instructing signal that makes an attenuation amount of transmission power decreased when a received power difference in the class is smaller than the power-suppressed threshold value, and that makes the attenuation amount of the transmission power increased when the received power difference in the class is greater than the power-suppressed threshold value; and determining an attenuation amount by integrating the attenuation instructing signals over a predetermined period of time, and calculating an attenuation amount of a radio signal to be transmitted to a terminal station according to the integrated value of the attenuation instructing signals.

In the transmission power control method according to next invention, the step of controlling suppression of the interference signal includes previously storing an attenuation-instructed threshold value as a threshold value of a received power difference for determining whether a control for suppression of transmission power is instructed; comparing a received power difference of the interference signal with the attenuation-instructed threshold value; and generating a transmission power suppress command for instructing suppression of the transmission power of the interference signal when the received power difference is the attenuation-instructed threshold value or larger, and the step of controlling transmission power includes storing transmission power suppress commands transmitted from the terminal station to the base station during a predetermined period of time; and determining an attenuation amount by counting a total number of the stored transmission power suppress commands, and determining an attenuation amount of the transmission power of a radio signal to be transmitted to the terminal station.

### BRIEF DESCRIPTION OF THE DRAWINGS

FIG. 1 is a block diagram of a wireless communication system according to a first embodiment of the present invention;

FIG. 2 illustrates an example of a slot format of a downlink in the first embodiment;

FIG. 3 is a block diagram of a received power monitor of a terminal station in the first embodiment;

FIG. 4 illustrates how to control suppression of transmission power in an interfering base station in the first embodiment;

FIG. 5 illustrates an example of a slot format of an uplink in the first embodiment;

FIG. 6 is a block diagram of a transmission power controller in the first embodiment;

FIG. 7 is a block diagram of a weighting coefficient calculator in the first embodiment;

FIG. 8 is a block diagram of a weighting coefficient calculator according to a second embodiment of the present invention;

FIG. 9 illustrates how to control suppression of transmission power in a command analyzer in the second embodiment;

FIG. 10 illustrates how to control suppression of transmission power in an interfering base station according to a third embodiment of the present invention;

FIG. 11 is a block diagram of a weighting coefficient calculator in the third embodiment;

FIG. 12 illustrates a structural example of a wireless communication system which covers a service area with a plurality of radio cell, sectors, and radio beams; and

FIG. 13 is a block diagram of the conventional wireless communication system.

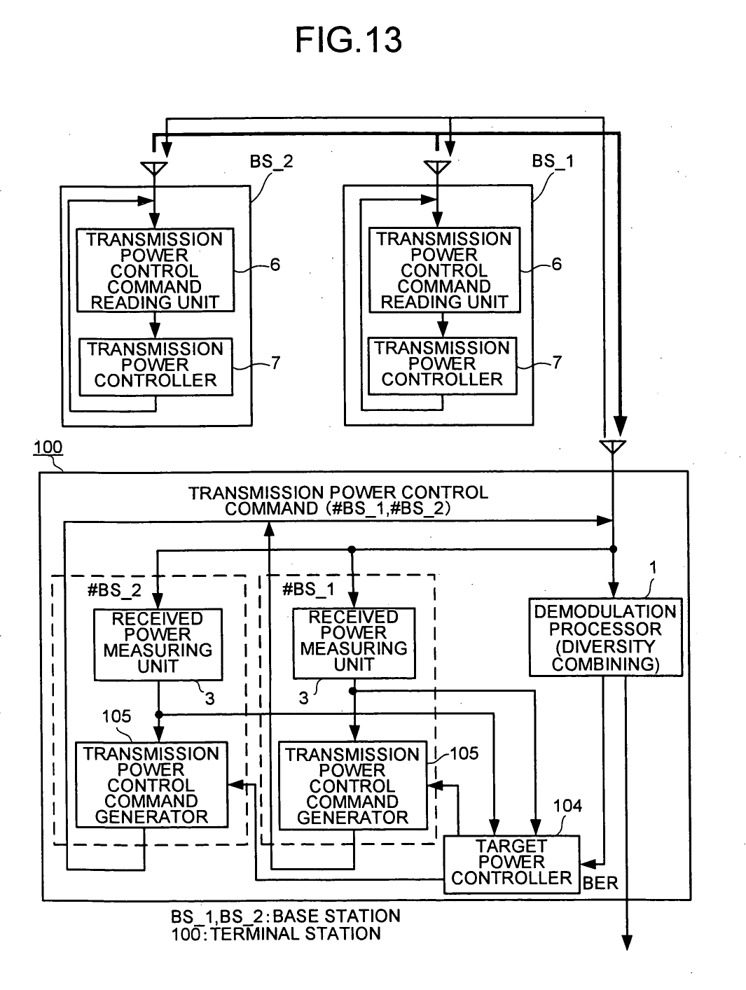

### BEST MODE FOR CARRYING OUT THE INVENTION

### FIRST EMBODIMENT

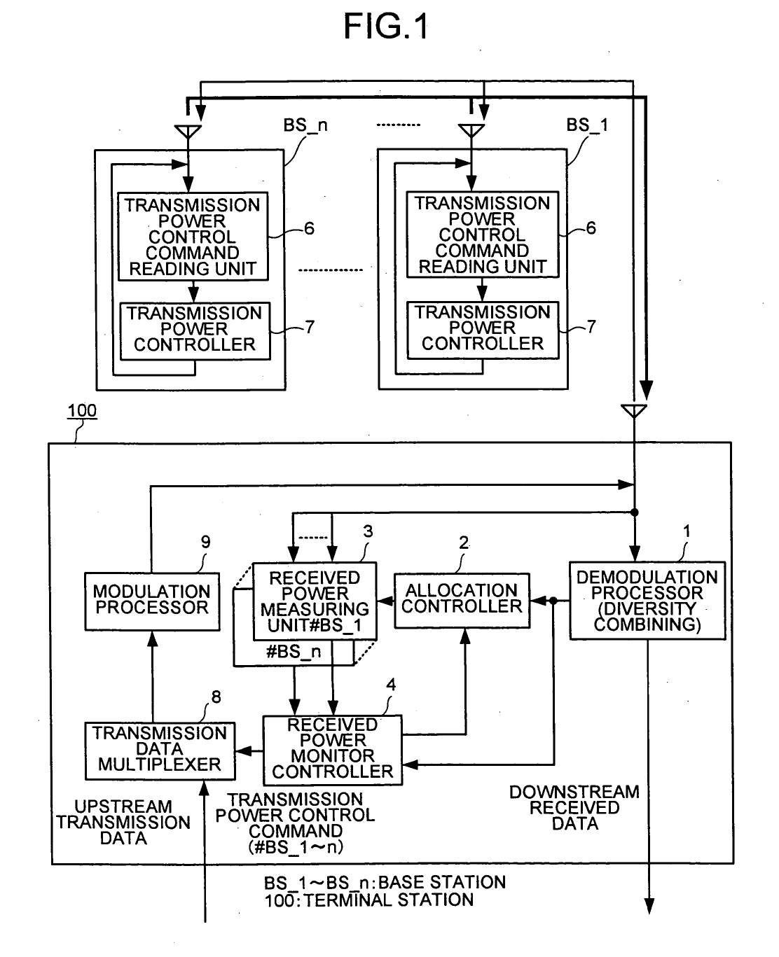

FIG. 1 is a block diagram of a wireless communication system according to a first embodiment of the present invention. As shown in FIG. 1, the wireless communication system includes a terminal station 100, and a plurality of base stations BS_1 to BS_n that transmit the same data to the terminal station 100. The terminal station 100 and the base stations BS_1 to BS_n employ a CDMA system, and each of the stations subjects transmission data to spreading modulation using discrete spreading code, and wirelessly transmits the data. The terminal station 100 receives a plurality of radio signals transmitted from the base stations BS_1 to BS_n, and performs site diversity combining on the received signals to reproduce received data.

The terminal station 100 includes a demodulation processor 1 that discretely performs a despreading process on the radio signals from the base stations BS_1 to BS_n to generate demodulated signals, and performs diversity combining on the demodulated signals to reproduce downstream received data. The terminal station 100 also includes an allocation controller 2 that specifies a base station as a target for transmission power control based on control information from the base stations BS_1 to BS_n, and a plurality of received power measuring units 3 that correspond to the base stations BS_1 to BS_n, and respectively measure received powers of radio signals from the base stations. The terminal station 100 further includes a received power monitor controller 4 that generates a transmission power control command for each of the base stations BS_1 to BS_n based on the measured received powers, and a transmission data multiplexer 8 that multiplexes the generated transmission power commands targeted to the base stations BS_1 to BS_n on upstream transmission data to be transmitted from the terminal station 100 to the base stations. The terminal station 100 further includes a modulation processor 9 that subjects the multiplexed upstream transmission data to spreading modulation with a spreading code specific to the terminal station 100 and transmits the modulated data to the base stations BS_1 to BS_n.

On the other hand, each of the base stations BS_1 to BS_n includes a transmission power control command reading unit 6 that performs the despreading demodulation process on the radio signal transmitted from the terminal station 100 and extracts the transmission power control command targeted to the base station. Each of the base stations BS_1 to BS_n also includes a transmission power controller 7 that controls the transmission power of the radio signal for the terminal station 100 according to the transmission power control command.

It is noted that FIG. 1 illustrates only the base stations BS_1 to BS_n of a plurality of base stations. However, in an actual case, the terminal station 100 receives radio signals also from another base stations that are not shown in FIG. 1, performs site diversity combining on the received radio signals to reproduce downstream received data. The base stations BS_1 to BS_n have the same configuration as one another.

The operation of the wireless communication system according to the first embodiment is explained below.

Each of the base stations BS_1 to BS_n stores the same downstream transmission data to be transmitted to the terminal station 100 through a communication network (not shown in FIG. 1).

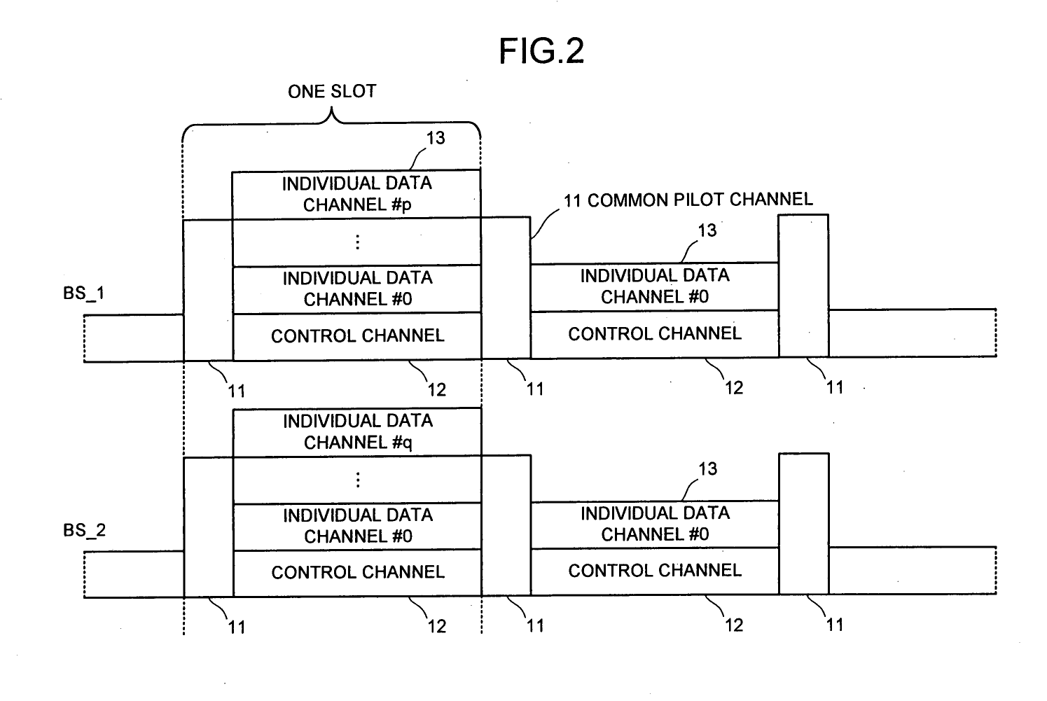

Each of the base stations BS_1 to BS_n transmits downstream data to the terminal station 100 according to the slot format of a downlink as shown in FIG. 2. FIG. 2 illustrates the slot format of the downlink. One slot includes a common pilot channel 11 consisting of known pilot series inserted for establishing synchronization between the terminal station 100 and each of the base stations BS_1 to BS_n, a control channel 12 used to transmit control signals from the base stations BS_1 to BS_n to the terminal station 100, and a plurality of individual data channels 13 used to individually transmit downstream data to the terminal station 100 connected to the base stations.

The common pilot channel 11 is transmitted with predetermined power from the base stations BS_1 to BS_n to the terminal station 100. The terminal station 1 00 measures a received power of the common pilot channel 11, and compares the measured received power with the known transmission power to estimate a propagation path loss between the terminal station 100 and each of the base stations BS_1 to BS_n.

Each of the base stations BS_1 to BS_n performs code-multiplexing on the individual data channels 13 to be transmitted (as shown in FIG. 2, BS_1 includes #0 to #p, BS_2 includes #0 to #q), while holding mutual slot synchronization. The terminal station 100 selectively demodulates data in a particular individual data channel (e.g., #0) among the individual data channels 13 transmitted from the base stations BS_1 to BS_n, and performs diversity combining on the demodulated data to reproduce downstream received data.

The control channel 12 is used to inform the terminal station 100 from the base stations BS_1 to BS_n of information for allocation of individual data channels, information for specifying a peripheral base station usable for site diversity, and a transmission power of the common pilot channel for the base stations BS_1 to BS_n.

In the terminal station 100, the demodulation processor 1 detects a known pilot series included in the common pilot channel 11, synchronizes the terminal station 100 and each of the base stations BS_1 to BS_n, receives the control channel 12 to acquire control information required for performing site diversity combining, and transmits the control information to the allocation controller 2 and the received power monitor controller 4.

The allocation controller 2 specifies particular base stations BS_1 to BS_n that transmit downstream data to the terminal station 100 based on the control information, and allocates corresponding received power measuring units 3 to the specified base stations BS_1 to BS_n. The received power measuring units 3 repeatedly measure the received power of the common pilot channel for the corresponding base stations BS_1 to BS_n in each slot, and inform the received power monitor controller 4 of the measured received powers.

The received power monitor controller 4 performs transmission power control for the base stations BS_1 to BS_n as explained below each time the received power is measured.

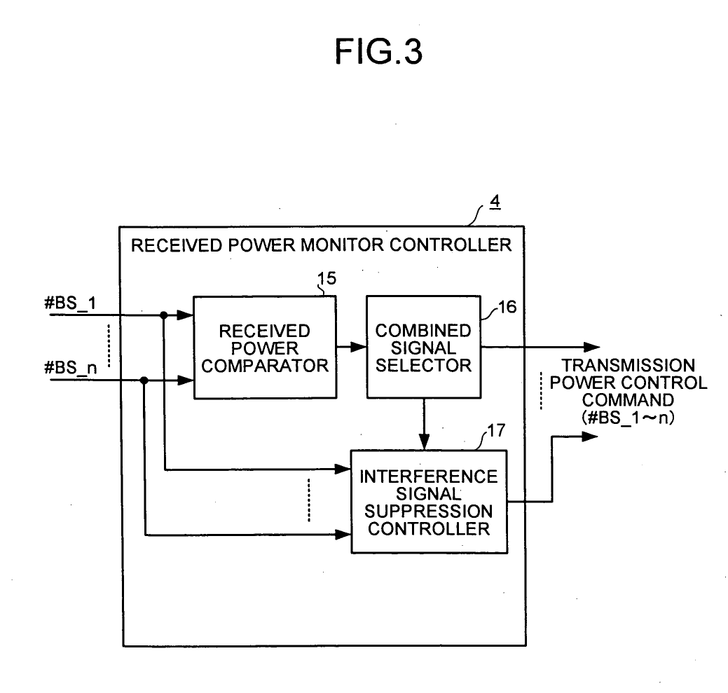

FIG. 3 is a block diagram of the received power monitor 4. The received power monitor controller 4 includes a received power comparator 15 that sorts received powers for the base stations BS_1 to BS_n, and a combined signal selector 16 that specifies the predetermined number of base stations to be actually used for site diversity by the terminal station 100 based on the result of sorting. The received power monitor controller 4 also includes an interference signal suppression controller 17 that controls suppression of the transmission power of any base station that has not been selected by the combined signal selector 16, of the base stations BS_1 to BS_n allocated to the terminal station 100.

The received power comparator 15 sorts the calculated received powers of the base stations BS_1 to BS_n in descending order, and informs the received combined signal selection 16 of the result of sorting. The sorting process of the received powers is performed each time the received power measuring unit 3 measures the received power.

The combined signal selector 16 selects a base station such that a signal received from the base station is used for site diversity based on the result of sorting of the received powers. The combined signal selector 16 previously stores the number K of base stations (e.g., K=3 stations) to be used for site diversity, and specifies base stations ranging from one having the maximum received power to a K-th one, as “power-combined base stations” used for site diversity combining.

The number K of base stations used for site diversity is a value that is previously obtained through experiments and is sufficient enough to obtain desired demodulation capability in the demodulation process of the terminal station 100.

The combined signal selector 16 generates “transmission power maintain command”, as a command for transmission power control for the specified K-units of power-combined base stations, consisting of information (e.g., CS-ID specific to each base station) for specifying a power-combined base station and information (e.g., “1111”) for instructing to maintain present transmission power.

On the other hand, the radio signal of a base station that has not been selected as a power-combined base station is not used for site diversity combining in the terminal station 100, and acts only as an interference signal. Therefore, the combined signal selector 16 informs an interference signal suppression controller 17 of the information for specifying a base station (hereinafter, “interfering base station”) that has not been selected as the power-combined base station.

The interference signal suppression controller 17 generates a transmission power control command for controlling suppression of each transmission power of the interfering base stations.

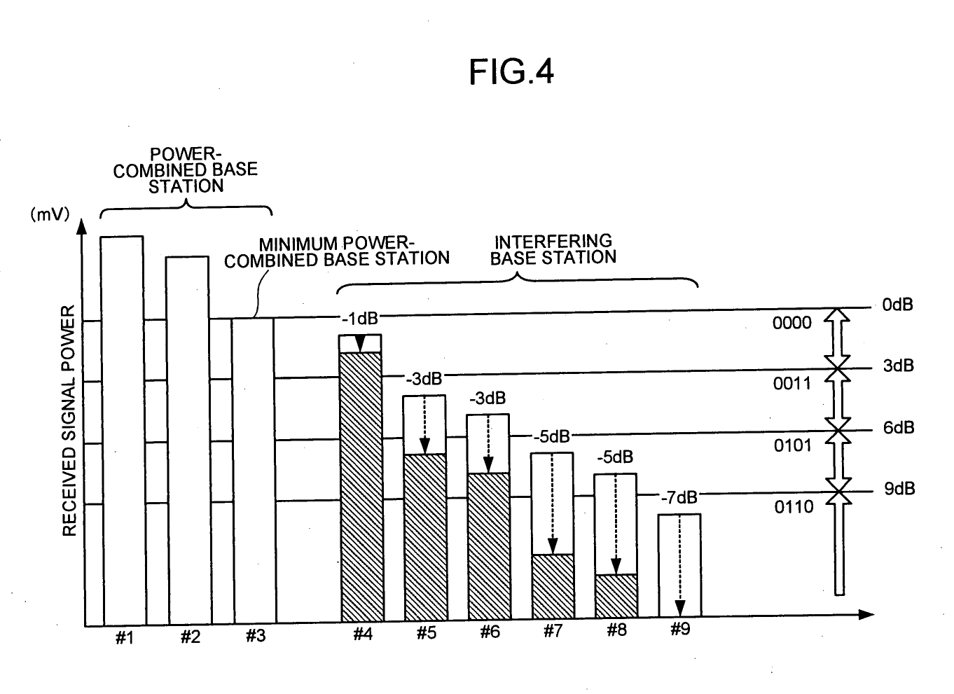

FIG. 4 illustrates how to control suppression of the transmission power by the interference signal suppression controller 17 (herein, the total number n of base stations=9). At first, the interference signal suppression controller 17 compares the received power of each of the interfering base stations #4 to #9 with the received power of a power-combined base station #3 (hereinafter, “minimum power-combined base station”) as the K-th base station from the result of sorting the received powers, and sequentially calculates a difference between the received powers (hereinafter, “received power difference”).

On the other hand, the interference signal suppression controller 17 previously stores threshold values of an interference power difference with which the interfering base stations are classified into a plurality of classes. In the example of FIG. 4, the interference signal suppression controller 17 stores threshold values of three received power differences such as 3 dB, 6 dB, and 9 dB. The interference signal suppression controller 17 classifies the interfering base stations #4 to #9 into a plurality of classes according to the threshold values.

In the example shown in FIG. 4, the interfering base station #4 is specified as a class with a received power difference of 0 to 3 dB, the interfering base stations #5 and #6 as a class with the received power difference of 3 to 6 dB, the interfering base stations #7 and #8 as a class with the received power difference of 6 to 9 dB, and the interfering base station #9 as a class with the received power difference greater than 9 dB.

The interference signal suppression controller 17 generates information indicating any of the classes related to the received power differences (hereinafter, “power-difference class information”) for each interfering base station belonging to each of the specified classes.

In order to control transmission power as appropriately as possible even if a propagation error occurs in a wireless zone during transmission of the power-difference class information to the base station, the interference signal suppression controller 17 uses an information series having mutual orthogonality and redundancy like Walsch code as the power-difference class information.

More specifically, as the power-difference class information, information series “0000” is used for the interfering base station #4 belonging to the class of 0 to 3 dB, and “0011” is allocated to the class of 3 to 6 dB, “0101” to the class of 6 to 9 dB, and “0110” to the class greater than 9 dB, respectively.

The interference signal suppression controller 17 generates a “transmission power suppress command” including information (e.g., BS-ID specific to a base station) for specifying a particular interfering base station in each of the interfering base stations #4 to #9 and the power-difference class information.

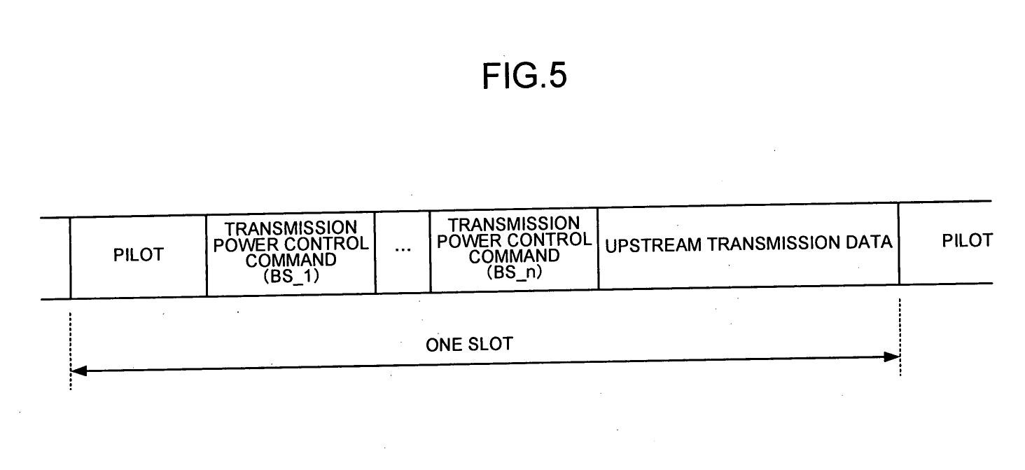

As explained above, when “transmission power maintain command” or “transmission power suppress command” (hereinafter, both are simply referred to as “transmission power control command” ) is generated for all the power-combined base stations and interfering base stations, the transmission data multiplexer 8 multiplexes the transmission power control commands for the base stations BS_1 to BS_N onto the upstream transmission data to be transmitted from the terminal station 100 to the base stations BS_1 to BS_N according to the upstream slot format as shown in FIG. 5. The modulation processor 9 subjects the upstream transmission data multiplexed on the slot data to spreading modulation process, and transmits the modulated data to the base stations.

Each of the base stations BS_1 to BS_N receives a radio signal transmitted from the terminal station 100. Each of the transmission power control command reading units 6 in the base stations BS_1 to BS_N performs the despreading demodulation process on the radio signal, reads a plurality of transmission power control commands multiplexed on the upstream transmission data, extracts only the transmission power control command targeted to the base station based on the CS-ID included in each of the transmission power control commands, and informs the transmission power controller 7 of the corresponding command.

The transmission power controller 7 controls the transmission power of the individual data channel 13 allocated to the terminal station 100 based on the transmission power control command.

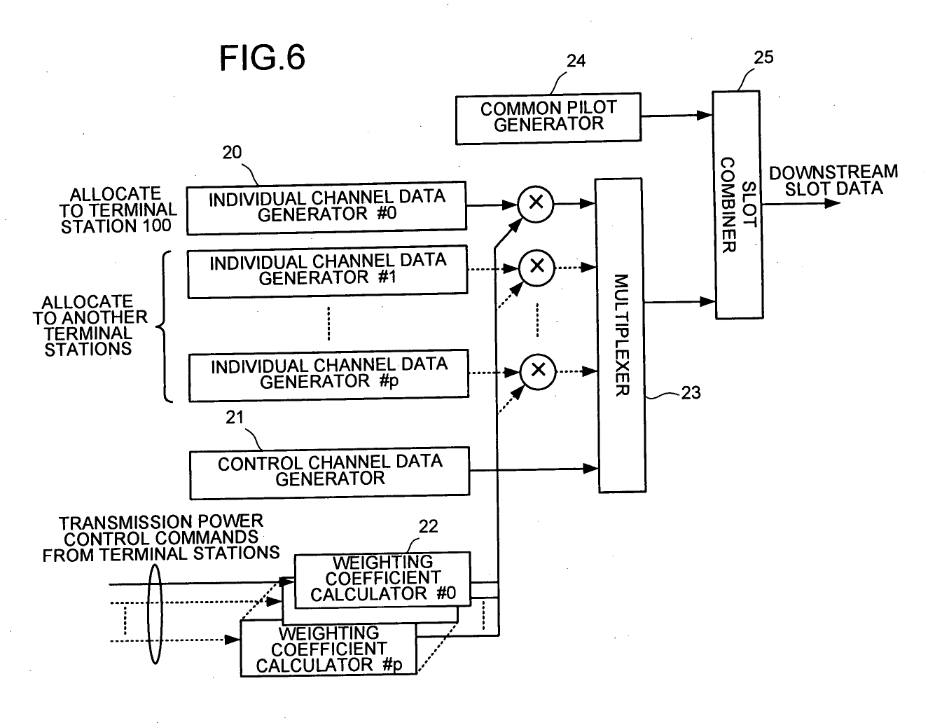

FIG. 6 is a block diagram of the transmission power controller 7. The transmission power controller 7 includes a plurality of individual channel data generators 20 that generate channel data for the individual data channels #1 to #p transmitted from the base station, and a control channel data generator 21 that generates control information to be transmitted over the control channel 12. The transmission power controller 7 also includes a plurality of weighting coefficient calculators 22 each of which calculates a weighting coefficient of each of the corresponding individual data channels #1 to #p and controls transmission power, and a multiplexer 23 that multiplexes the individual channel data #1 to #p each having a predetermined weight on the control data channel 12. The transmission power controller 7 further includes a common pilot generator 24 that generates a known pilot series to be inserted into the common pilot channel 11, and a slot combiner 25 that receives the multiplexed data output from the multiplexer 23 and the pilot series to generate downstream slot data as shown in FIG. 2.

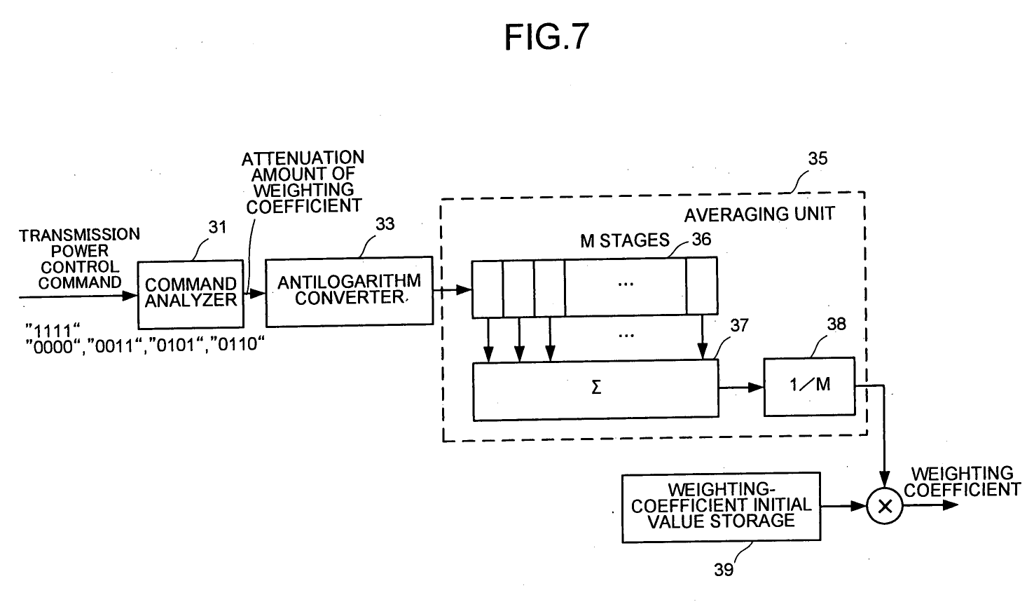

FIG. 7 is a block diagram of the weighting coefficient calculator 22. The weighting coefficient calculator 22 includes a command analyzer 31 that extracts the information series inserted in the transmission power command and outputs an attenuation amount of each weighting coefficient for the individual data channels 13, and an antilogarithm converter 33 that converts the attenuation amount of the weighting coefficient calculated as a logarithm to an antilogarithm. The weighting coefficient calculator 22 also includes an averaging unit 35 that sequentially outputs moving averages of the attenuation amount, and a weighting-coefficient initial value storage 39 that stores a preset default value of the weighting coefficient for a corresponding individual data channel 13.

The transmission power control command informed from the transmission power control command reading unit 6 is input into the command analyzer 31 of the weighting coefficient calculator 22. The command analyzer 31 extracts a particular information series (e.g., “1111”) indicating “transmission power maintain command” or power-difference class information (“0000”, “0011”, “0101”, or “0110”) indicating “transmission power suppress command”, from the transmission power control command.

Since a transmission error is added, on a link, to the transmission power control command received from the terminal station 100, the transmission power control command may not match with any of the information series (“1111 ”, “0000”, “0011 ”, “0101”, and “0110”). Therefore, the command analyzer 31 calculates a correlation value between an information series, having a likelihood of including the transmission error, extracted from the transmission power control command and each of the desired information series (“1111”, “0000”, “0011”, “0101”, and “0110”). The command analyzer 31 then determines the information series indicating the highest correlation between the two as an information series included in the transmission power control command.

As a result, if the extracted transmission power control command is determined as “transmission power suppress command” (the base station is the interfering base station), the command analyzer 31 determines the attenuation amount of the weighting coefficient for the individual data channel 13 according to the power-difference class information included in the “transmission power suppress command”.

As shown in FIG. 4, for example, if-the power-difference class information is “0000” (received power difference: 0 to 3 dB), then an attenuation amount of the transmission power is set to −1 dB, if it is “0011” (received power difference: 3 to 6 dB), then the attenuation amount is set to −3 dB, if it is “0101” (received power difference: 6 to 9 dB), then the attenuation amount is set to −5 dB, and if it is “0110” (received power difference: 9 dB or more), then the attenuation amount is set to −7 dB. In this manner, each attenuation amount of the weighting coefficient for the individual data channels 13 is determined according to the power-difference class information included in the “transmission power suppress command”.

As explained above, the attenuation amount of the weighting coefficient for the transmission power is set small when the received power difference is small (attenuation amount in the class of received power difference of 0 to 3 dB: −1 dB), and the attenuation amount of the weighting coefficient for the transmission power is set larger when the received power difference is greater (attenuation amount in the class of received power difference of 9 dB or more: −7 dB). By thus setting, the transmission power of the interfering base station having a small received power difference is slowly suppressed, but the transmission power of the interfering base station having a greater received power difference is speedily suppressed.

On the other hand, if the extracted transmission power control command is determined as “transmission power maintain command” (the base station is a power-combined base station), the command analyzer 31 sets the attenuation amount of the weighting coefficient for the individual data channel 13 to 0 dB.

The antilogarithm converter 33 converts each attenuation amount (0 dB, −1 dB, −3 dB, and −5 dB) of the weighting coefficient calculated as logarithms to antilogarithms. The attenuation amount of the weighting coefficient converted to the antilogarithm is input to the averaging unit 35, and the moving averaging process is performed on the attenuation amount over a predetermined period of time for averaging. In the example of FIG. 7, the averaging unit 28 includes an M-stage shift register 36, an adder 37 that calculates a sum of the attenuation amounts stored in the stages of the shift register 36, and a divider 38 that divides the output of the adder 37 by the number of stages M of the shift register. The averaging unit 35 performs moving averaging process on the attenuation amount of the weighting coefficient over an M slot period of time to suppress an abrupt change in the weighting coefficient.

The default value of the weighting coefficient for the transmission power of the individual data channel previously stored in the weighting-coefficient initial value storage 39 is multiplied by the averaged attenuation amount of the weighting coefficient, and a weighting coefficient for the individual data channel 13 is calculated.

The weighting coefficient calculators 22 discretely calculate each weighting coefficient for the corresponding individual data channels #0 to #p.

The channel data for the individual data channels #0 to #p generated in individual channel data generators 20 is multiplied by each corresponding weighting coefficient to be input in the multiplexer 23. In the individual data channel 13 to which “transmission power suppress command” is transmitted from the terminal station 100, the weighting coefficient is decreased, and the transmission power from the base station is suppressed. On the other hand, in the individual data channel 13 to which “transmission power maintain command” is transmitted from the terminal station 100, the weighting coefficient is maintained at the default value, and therefore, the transmission power from the base station is not suppressed.

The multiplexer 23 receives each transmission data for the weighted individual data channels #0 to #p and control information output from the control channel data generator 21, and performs code-multiplexing on them to be output. Further, the slot combiner 25 inserts the common pilot channel 11 in the multiplexed data to sequentially generate downstream slot data, performs spreading modulation process on the slot data, and transmits the modulated slot data to the terminal station 100.

As explained above, in the wireless communication system according to the first embodiment, the terminal station 100 selects a power-combined base station used for site diversity based on each received power of the base stations BS_1 to BS_n. The terminal station 100 also performs transmission power control on another interfering base station that has not been selected as the power-combined base station so that the transmission power of a radio signal from the interfering base station to the terminal station 100 is suppressed. Therefore, influence of interference due to the radio signal transmitted from the interfering base station is reduced to allow improvement in demodulation capability of the terminal station 100.

By making effective use of radio resources of the whole wireless communication system, it is possible to enhance the capacity for accommodating terminal stations in the whole wireless communication system, and to achieve lower power consumption of the whole wireless communication system.

Further, the interfering base station having a small received power difference sets small the attenuation amount of the transmission power, and the interfering base station having a larger received power difference sets larger the attenuation amount of the transmission power. By thus setting, it is possible to control high-speed suppression of an interference signal from the interfering base station having the large received power difference. Furthermore, even if the power-combined base station as a target for site diversity is switched during movement of the terminal station 100, it is also possible to reduce degradation of communication quality due to switching between the base stations.

As the transmission power control commands transmitted from the terminal station 100 to the base stations BS_1 to BS_n, the information series having predetermined redundancy is employed. Therefore, it is possible to reduce influence of a transmission error occurring on a link and accurately control the transmission power.

In the wireless communication system according to the first embodiment, the received power measuring units 3 in the terminal station 100 measure received powers of the base stations BS_1 to BS_n, and the received power monitor controller 4 controls the transmission power according to the received powers. However, the transmission power control is not performed based on only the received powers.

For example, each of the received power measuring units 3 calculates an average power obtained by adding the square of a symbol signal in a pilot series included in the common pilot channel 11 and dividing the addition by the number of symbols in the pilot series, and also calculates an interference power obtained as a spread of the received power for each symbol in the pilot series. The received power measuring unit 3 sequentially outputs a signal power-to-interference power ratio (SIR) as a ratio between the average power and the interference power for the base stations BS_1 to BS_n. The received power monitor controller 4 may select a power-combined base station in the same manner as explained above based on each signal power-to-interference power ratio of the base stations BS_1 to BS_n, and control suppression of the transmission power for the interfering base station.

The received power measuring unit 3 measures a received power of each downstream slot, but this is not limited to this structure. Therefore, the received power measuring unit 3 may calculate each average value of the received powers and the signal power-to-interference power ratios for the preset slots, and the received power monitor controller 4 may generate a transmission power control command based on the average values.

Furthermore, the received power measuring unit 3 may include a low-pass filter having a cut-off frequency that has been previously determined through experiments, and perform filtering on the received power or the signal power-to-interference power ratio to generate a transmission power control command based on the output value of the filter.

In such a configuration, influence of instantaneous fluctuation in the received power due to fading is reduced. Thus, it is possible to realize transmission power control capable of highly precisely compensating for the influence of propagation path loss between the terminal station. 100 and each of the base stations BS_1 to BS_n.

The transmission data multiplexer 8 of the terminal station 100 multiplexes the transmission power control commands for the base stations BS_1 to BS_n onto the upstream transmission data in each upstream slot according to the upstream slot format as shown in FIG. 5. However, the upstream slot format is not limited to such a structure, and the following structure may be employed. That is, transmission power control commands for the predetermined number of base stations are sequentially inserted in each upstream slot in such a manner that the transmission power control command for the base station BS_1 is inserted into a first upstream slot and the transmission power control command for the base station BS_2 is inserted into a second upstream slot. The transmission power control commands for the whole base stations BS_1 to BS_n may be transmitted using the plurality of upstream slots.

### SECOND EMBODIMENT

In the first embodiment, the transmission power controller 7 in the interfering base station controls only suppression of the transmission power for the individual data channels 13. However, in the second embodiment, the transmission power controller 7 decreases the attenuation amount of the transmission power, which has been suppressed, for any individual data channel 13 according to an instruction from the terminal station 100 (that is, the suppressed transmission power is increased).

The wireless communication system according to the second embodiment is different from that of the first embodiment only in the configuration of the weighting coefficient determining units 22 in the base stations BS_1 to BS_n, and the rest of the components have the same configuration as those of the first embodiment. Therefore, only the configuration and operation of the weighting coefficient calculator 22 are explained below.

The transmission power control command transmitted from the terminal station 100 is extracted by each transmission power control command 6 in the base stations BS_1 to BS_n, and the extracted command is informed to the transmission power controller 7.

The transmission power control command has, like in the first embodiment, “transmission power maintain command” for instructing the power-combined base station to maintain the transmission power, and “transmission power suppress command” including the power-difference class information (class of 0 to 3 dB: “0000”, class of 3 to 6 dB: “0011”, class of 6 to 9 dB: “0101”, and class greater than 9 dB: “0110”) indicating the classes of the interference power difference to which the interfering base stations belong. Each of the transmission power controllers 7 in the base stations BS_1 to BS_n reads out an information series of the “transmission power suppress command” to ascertain a received power difference of the individual data channel 13 in the terminal station 100.

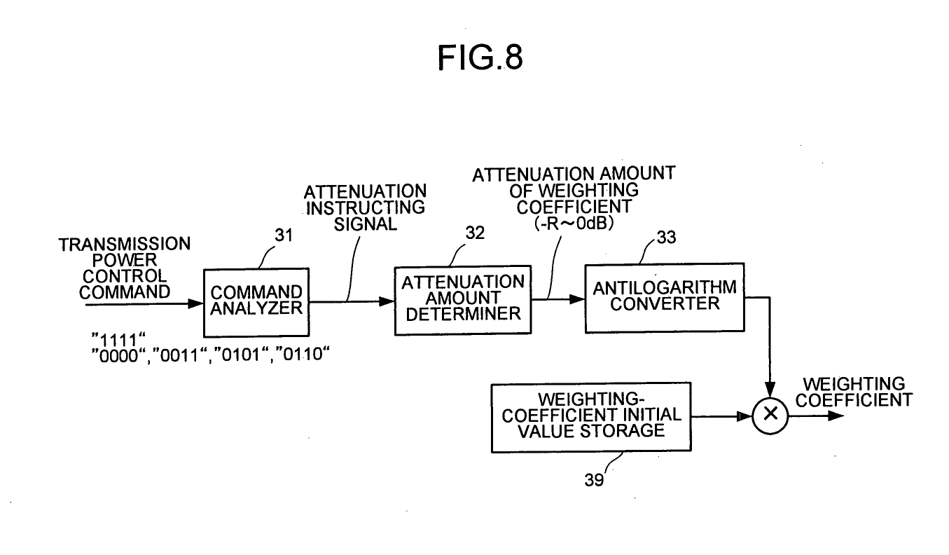

FIG. 8 is a block diagram of the weighting coefficient calculator 22 of the transmission power controller 7 in the second embodiment. The weighting coefficient calculator 22 includes a command analyzer 31 that extracts an information series for transmission power control inserted in the transmission power command and outputs an attenuation instructing signal for a weighting coefficient for the individual data channel 13, and an attenuation amount determiner 32 that determines an attenuation amount of the weighting coefficient for the individual data channel 13 according to the attenuation instructing signal.

When receiving the transmission power control command from the terminal station 100, the command analyzer 31 extracts a particular information series (“1111”) for instructing to maintain transmission power from the “transmission power maintain command”, and extracts power-difference class information (any of “0000”, “0011”, “0101”, and “0011”) for the individual data channel 13 from the “transmission power suppress command”.

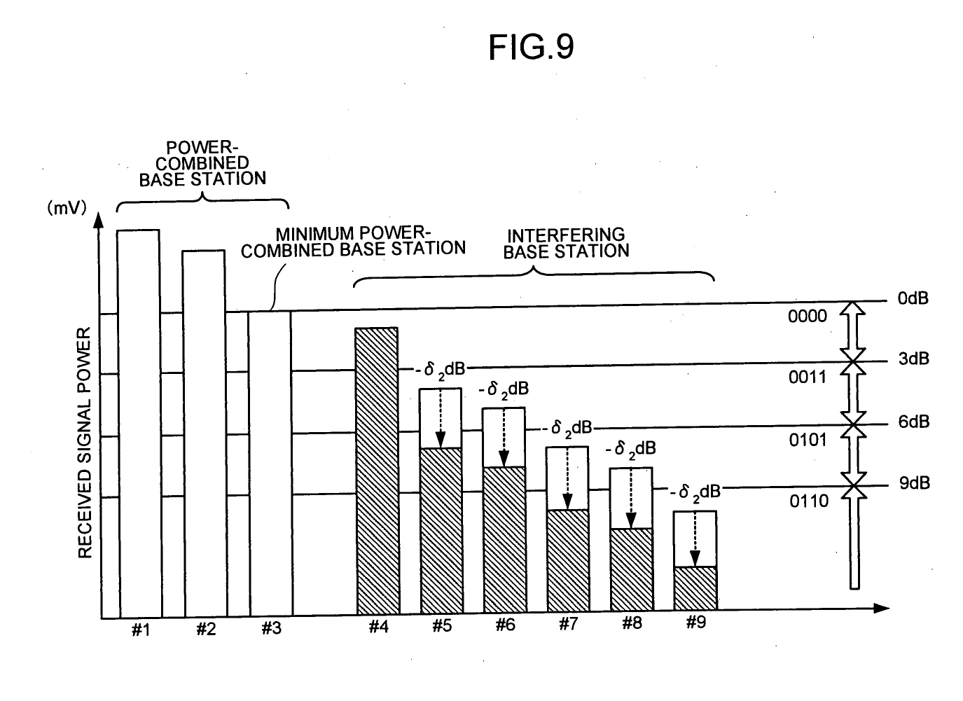

The command analyzer 31 determines a change amount of the weighting coefficient for the individual data channel 13 according to the extracted information series, and outputs the change amount as an attenuation instructing signal. The method of calculating the change amount of the weighting coefficient in the command analyzer 31 is explained with reference to FIG. 9. FIG. 9 illustrates how to control suppression of the transmission power in the command analyzer 31.

The command analyzer 31 previously stores threshold values for received power differences (hereinafter, “power-suppressed threshold value”) for determining whether the transmission power for the terminal station 100 is to be suppressed. As the power-suppressed threshold values for the base stations BS_1 to BS_n, appropriate values are previously obtained through experiments in order to obtain desired demodulation capability of the terminal station 100. The case where 3 dB is set as the power-suppressed threshold value is explained below.

The command analyzer 31 compares a received power difference corresponding to the power-difference class information with the power-suppressed threshold value. For example, in the interfering base station #4, the extracted information series is “0000”, and the command analyzer 31 compares the received power difference (0 to 3 dB) specified by the information series “0000” with the power-suppressed threshold value (3 dB).

In this case, the received power difference is the power-suppressed threshold value or less, and therefore, the command analyzer 31 determines that the interfering base station #4 has a likelihood of being selected as a power-combined base station during movement of the terminal station. The command analyzer 31 outputs a positive change amount “+δ₁ dB”, that makes the weighting coefficient for the individual data channel 13 close to the default value, as the attenuation instructing signal.

In the interfering base stations #5 to #9, the information series “0011”, “01101”, and “0110” are input in the command analyzer 31 according to each class of the interference power differences. In this case, as any of the received power differences (3 dB, etc.) exceeds the power-suppressed threshold value, the command analyzer 31 determines that the interfering base stations #5 to #9 have a low likelihood of being selected as the power-combined base stations, and outputs a negative change amount “−δ₂ dB” of the weighting coefficient as an attenuation instructing signal in order to suppress the transmission power for the individual data channel 13.

Each magnitude of the change amounts “+δ₁ dB” and “−δ₂ dB” of the weighting coefficient to be output as the attenuation instructing signal depends on responsivity to a request to control transmission power for the interfering base stations #4 to #9, and is previously determined through experiments.

On the other hand, in the power-combined base stations #1 to #3, the information series input to the command analyzer 31 is “1111” for instructing to maintain the transmission power. In this case, the command analyzer 31 outputs the change amount “0 dB” of the weighting coefficient as the attenuation instructing signal in order to maintain the transmission power of the individual data channel 13.

The attenuation amount determiner 32 integrates the attenuation instructing signals to determine an attenuation amount of the weighting coefficient for the individual data channel 13. The attenuation amount determiner 32 previously stores an allowable setting range (−R to 0 dB) of the attenuation amount, and the integrated value that is beyond the allowable setting range is rounded so as to fall within the allowable setting range (−R to 0 dB).

The antilogarithm converter 33 converts the attenuation amount of the weighting coefficient (−R to 0 dB) calculated as a logarithm to an antilogarithm. The default value of the weighting coefficient for the transmission power of the individual data channel previously stored in the weighting-coefficient initial value storage 39 is multiplied by the attenuation amount of the weighting coefficient having been converted to the antilogarithm, and the weighting coefficient for the individual data channel 13 is calculated.

As explained above, the interfering base station #4 having a received power difference that is the power-suppressed threshold value or less, adds the positive change amount “+δ₁ dB” to the attenuation amount of the transmission power so that the weighting coefficient of the transmission power approaches the preset default value. Therefore, in the interfering base station #4 having a likelihood of being used for site diversity combing process in the terminal station 100, even if the suppression has already been performed, the transmission power of the interfering base station #4 is increased to allow reduction in degradation of communication quality occurring when power-combined base stations are switched.

On the other hand, in the interfering base stations #5 to #9 each of which has a received power difference that is greater than the power-suppressed threshold value, the negative change amount “−δ₂ dB” is added to the attenuation amount of the transmission power in order to suppress the transmission power. Therefore, it is possible to speedily suppress the transmission power of any interfering base station having a low likelihood of being selected as the power-combined base station, and to improve demodulation capability of the terminal station 100.

The attenuation amount determiner 32 has a configuration of integrating the attenuation instructing signals to determine an amount of the weighting coefficient. Therefore, it is possible to suppress influence caused by instantaneous fluctuations in the received power due to noise or fading, and to accurately control the transmission power that reflects each received power difference for the base stations BS_1 to BS_n.

### THIRD EMBODIMENT

In the wireless communication system of the first embodiment, the received power monitor controller 4 respectively classifies the interfering base stations into a plurality of classes based on each received power, generates a predetermined “transmission power suppress command” for each class, and controls the transmission power. However, in the third embodiment, the received power monitor controller 4 in the terminal station 100 previously stores a threshold value of the received power difference for instructing the base station to suppress the transmission power, and transmission power control for the interfering base station can be easily performed based on the threshold value.

The wireless communication system of the third embodiment is different from the first embodiment only in the process of generating the transmission power control command in the received power monitor controller 4 of the terminal station 100 and in the process of controlling the transmission power of the individual data channels 13 in each of the transmission power controllers 7 of the base stations BS_1 to BS_n. The rest of processes in the controlling method are the same as those of the first embodiment. Therefore, only the received power monitor controller 4 and the method of controlling transmission power in the transmission power controller 7 are explained below.

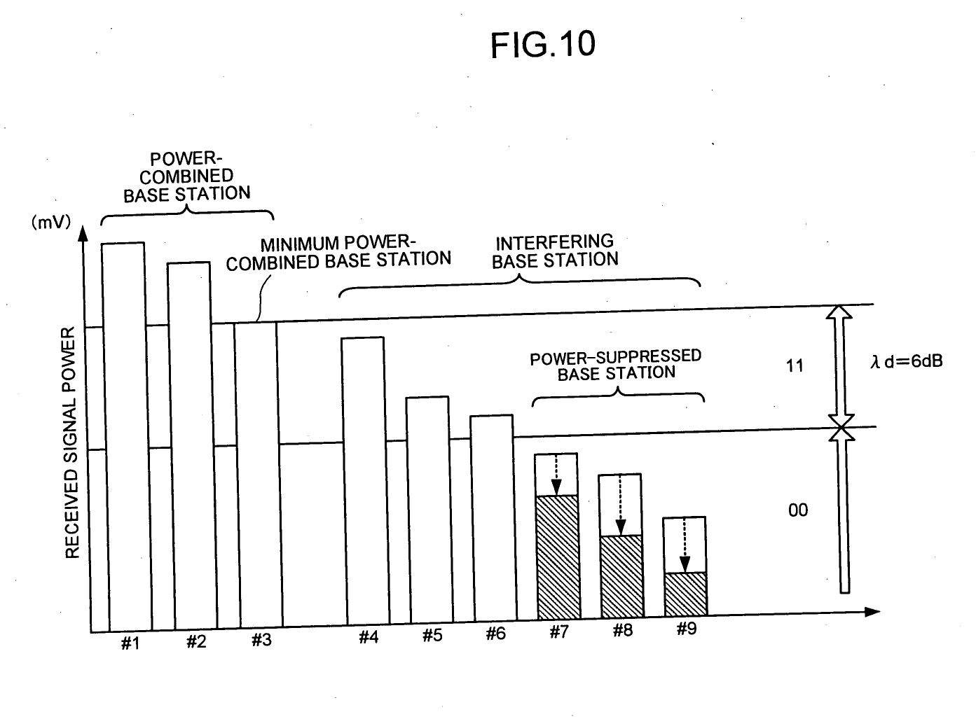

FIG. 10 illustrates how to control suppression of transmission power in the received power monitor controller 4 and the transmission power controller 7 according to the third embodiment. The method of generating a transmission power control command in the received power monitor controller 4 is explained below with reference to FIG. 10.

When each of the received power measuring units 3 measures a received power of the base stations BS_1 to BS_n, the received power monitor controller 4 sorts base stations #1 to #3 of K stations (when K=3) as power-combined base stations in descending order of received powers, and specifies any base stations other than the power-combined base stations as interfering base stations #4 to #9 in the same manner as that of the first embodiment.

The received power monitor controller 4 previously stores a threshold value λd (hereinafter, “attenuation-instructed threshold value”) of a received power difference between the received power of the minimum power-combined base station #3 and the received power of each interfering base station in order to specify a power-suppressed base station. In the example of FIG. 10, the attenuation-instructed threshold value λd=6 dB is previously set, and the received power monitor controller 4 specifies the interfering base stations #7 to #9 each having a received power difference that is the attenuation-instructed threshold value λd or more, each as an interfering base station that is instructed to suppress the transmission power (hereinafter, “power-suppressed base station”).

The received power monitor controller 4 generates each transmission power control command for the base stations BS_1 to BS_n in each slot in which each value of received power from the base stations BS_1 to BS_n is measured.

At first, the received power monitor controller 4 generates “transmission power maintain command” consisting of information (e.g., BS-ID specific to each base station) for specifying each of the power-combined base stations #1 to #3 and the interfering base stations #4 to #6 other than the power-suppressed base station, and a particular information series (e.g., “00”) for instructing to maintain transmission power.

On the other hand, the received power monitor controller 4 generates “transmission power suppress command” consisting of particular information for the power-suppressed base stations #7 to #9 and a particular information series (e.g., “11”) for instructing them to suppress the transmission power.

The information for transmission power control only represents either its suppression or maintenance, and therefore, the information can be informed with one-bit data (“0”or “1”). However, in the third embodiment, information series (“11”and “00”) each having redundancy as the information for the transmission power control are used.

Each transmission power control command generated for the base stations BS_1 to BS_n is multiplexed onto upstream transmission data by the transmission data multiplexer in the same manner as the first embodiment, and the multiplexed data is transmitted to the base stations BS_1 to BS_n.

Each of the transmission power control command reading units 6 in the base stations BS_1 to BS_n reads a transmission power control command targeted to a relevant base station, from the upstream radio signal transmitted from the terminal station 100 and inputs the read command to the transmission power controller 7. Each of the weighting coefficient calculators 22 of the transmission power controller 7 determines a weighting coefficient of channel data for a corresponding individual data channel 13 according to the transmission power control command.

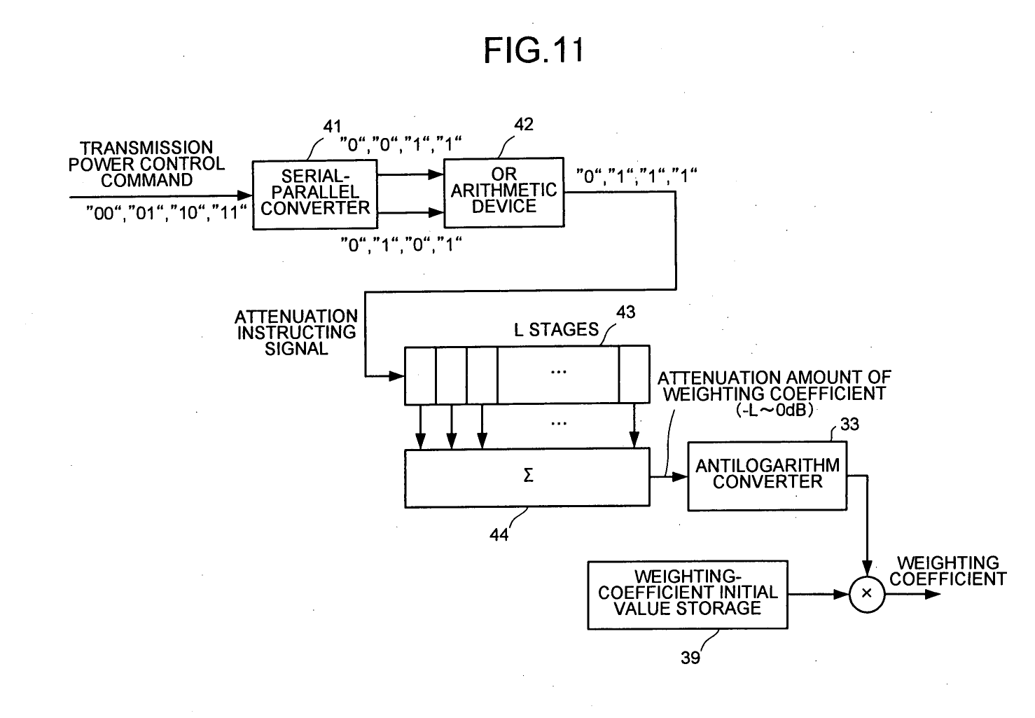

FIG. 11 is a block diagram of the weighting coefficient calculator 22. The weighting coefficient calculator 22 includes a converter 41 that extracts an information series for maintenance and suppression of the transmission power from the transmission power control command for each of the individual data channels 13 to perform serial-parallel conversion on the extracted information series. The weighting coefficient calculator 22 also includes an arithmetic device 42 that receives the information series having been subjected to the serial-parallel conversion, and sequentially performs OR operations between the information series to output an attenuation instructing signal indicating attenuation of the transmission power. The weighting coefficient calculator 22 further includes an L-stage shift register 43 that holds the attenuation instructing signals, and an adder 44 that adds the attenuation instructing signals for L slots in the past held in the shift register 43 and calculates an attenuation amount (−L to 0 dB) of the weighting coefficient for the individual data channel.

The serial-parallel converter 41 extracts each information series for transmission power control included in the transmission power control commands. The information series includes either the information series “00” indicating “transmission power maintain command” or the information series “11” indicating “transmission power suppress command”, but sometimes includes, in addition to the information series, an invalid information series such as “01” and “10” due to influence of transmission error that occurs on the link.

The serial-parallel converter 41 separates a first bit from a second bit of the information series to convert the separated bits to parallel data, and the OR arithmetic device 42 performs OR operation between the first bit and the second bit. As a result, the information series (“00”, “01”, “10”, “1”) included in the actually received transmission power control command is converted to information (hereinafter, “attenuation instructing signal”) consisting of “1” for instructing suppression of the transmission power and “0” for instructing maintenance of the transmission power. More specifically, the information series for the transmission power having a 2-bit length with redundancy “00”, “01”, “10”, and “11” are converted to attenuation instructing signals “0”, “1”, “1”, and “1”, respectively.

The attenuation instructing signals output from the OR arithmetic device 42 are sequentially input in the L-stage shift register 43. The adder 44 calculates a total sum of the attenuation instructing signals stored in the shift register 43 each time a new attenuation instructing signal is input in the shift register, and outputs the total sum as an attenuation amount (−L to 0 dB) of the weighting coefficient for the individual data channel. The attenuation amount (−L to 0 dB) of the weighting coefficient is calculated as a logarithm, but this amount is converted to an antilogarithm by the antilogarithm converter 33.

On the other hand, the weighting-coefficient initial value storage 39 presets a default value of the weighting coefficient, and in an initial state in which transmission power control is not performed by the terminal station 100, the default value is output as a weighting coefficient for the individual data channel 13.

When the attenuation amount of the weighting coefficient having been converted to the antilogarithm is output from the antilogarithm converter 33, the attenuation amount is multiplied by the default value of the weighting coefficient for the transmission power, and the weighting coefficient for the individual data channel 13 is calculated.

As a result, the “transmission power suppress command” for an individual data channel is transmitted from the terminal station 100, and the transmission power for the individual data channel from the base station is suppressed.

In the example of FIG. 10, for the power-suppressed base stations #7 to #9 to which the “transmission power suppress command” is transmitted, the received power in the terminal station 100 is suppressed. On the other hand, for the base stations #1 to #6 to which the “transmission power maintain command” is transmitted, the received power in the terminal station 100 is maintained.

In the wireless communication system of the third embodiment, the terminal station 100 previously stores an attenuation-instructed threshold value for instructing to suppress the transmission power, specifies an interfering base station having a received power difference that is greater than the attenuation-instructed threshold value, as a power-suppressed base station, and transmits “transmission power suppress command” for controlling to suppress the transmission power, to the power-suppressed base station. The power-suppressed base station controls so as to suppress the transmission power of the individual data channel 13 for the terminal station 100. Therefore, it is possible to speedily reduce the transmission power of interfering base stations having less likelihood of being used for site diversity combining in the terminal station 100. It is further possible to reduce power consumption of the whole wireless communication system and to reduce interference power produced in the system.

In addition to the power-combined base stations used for site diversity combining in the terminal station 100, the “transmission power maintain command” is transmitted to an interfering base station having a received power difference that is less than the attenuation-instructed threshold value λd so as to maintain the transmission power of the interfering base station. Thus, even if the power-combined base stations for site diversity are switched during movement of the terminal station 100, it is possible to minimize degradation of reception quality in the terminal station 100.

In the third embodiment, each of the weighting coefficient calculators 22 of the base stations BS_1 to BS_n converts the information series, for the transmission power control, that has been converted to parallel data by the serial-parallel converter 41 into each attenuation instructing signal having a 1-bit length in the OR arithmetic device 42. However, as a converter of the information series to the attenuation instructing signal, an AND arithmetic device may be used instead of the OR arithmetic device 42.

In this case, the information series each having redundancy for the transmission power control “00”, “01”, “10”, and “11” are converted into attenuation instructing signals “0”, “0”, “0”, and “1”, respectively. Therefore, when a transmission error occurs in the information series (“01”, “10”), the information series is converted to an attenuation instructing signal “0” indicating maintenance of the transmission power. Thus, it is possible to avoid inappropriate suppression of the transmission power of the individual data channel 13 based on the transmission error.

The received power measuring unit 3 and the received power monitor controller 4 in the terminal station 100 generate transmission power control commands based on the respective values of received power from the base stations BS_1 to BS_n, but the configuration is not thus limited. Instead of the received powers for the base stations BS_1 to BS_n, a signal power-to-interference power ratio (SIR) may be used to specify a power-combined base station and a power-suppressed base station and generate the transmission power control commands for the base stations BS_1 to BS_n.

Furthermore, in the third embodiment, the terminal station 100 measures a received power of each downstream slot, generates a transmission power control command, and transmits the command. Each of the base stations BS_1 to BS_n calculates a weighting coefficient for each of the individual data channels 13 and controls the transmission power of each upstream slot, but the method is not thus limited. For example, the method as follows may be employed. That is, the terminal station 100 may measure a received power and generate a transmission power control command once in the predetermined number of slots, and each of the base stations BS_1 to BS_n may control the transmission power of the individual data channel 13 at the predetermined upstream slot intervals.

As explained above, in the embodiment of the present invention, the case, in which the terminal station 100 measures each received power for the base stations BS_1 to BS_n and controls transmission power for each of the terminal stations BS_1 to BS_n, has been explained.

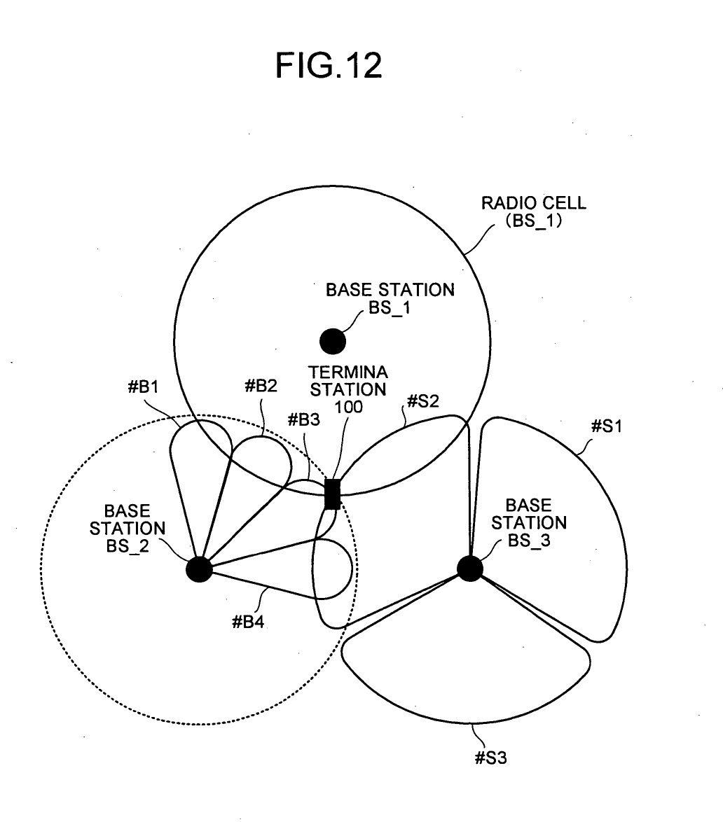

In contrast, as shown in FIG. 12, the wireless communication system as follows is considered. That is, the base station BS_1 is a non-directional radio cell, the base station BS_2 covers a plurality of radio beams #B1 to #B4, and the base station BS_3 covers a plurality of sectors #S1 to #S3, and the terminal station 100 receives radio signals from the radio base stations BS_1 to BS_3 to perform site diversity combining on the radio signals. However, even such a wireless communication system can also employ the transmission power control in the terminal station 100 in the same manner as that of the first embodiment to third embodiment. That is, the terminal station 100 can measure each received power for the radio cell, the sectors #S1 to #S3, and the radio beams #B1 to #B4, and performs the transmission power control in each of the radio cells, the sectors, and the radio beams. In this case, it is possible to obtain the same effect as the case where the transmission power control is performed in each of the base stations.

As explained above, according to the present invention, the terminal station measures each received power of radio signals transmitted from the base stations, and selects the predetermined number of combined signals used for diversity combining. The terminal station also calculates a received power difference between an interference signal of a base station that has not been selected as a power-combined base station and the combined signal, generates a transmission power suppress command for instructing suppression of the transmission power of the interference signal based on the received power difference, and controls the corresponding base station to suppress transmission power based on the transmission power suppress command. Therefore, it is possible to reduce the received power of the interference signal not used for diversity combining and enhance demodulation capability of the terminal station.

According to the next invention, the terminal station classifies the interference signals into any of a plurality of power difference classes, and generates a transmission power suppress command including an information series for specifying the power difference class to be transmitted to the interfering base stations. Each of the interfering base stations determines an attenuation amount of the transmission power corresponding to the power difference class. Therefore, it is possible to control suppression of transmission power according to the received power difference of the interference signal, reduce the received power of the interference signal, and enhance demodulation capability of the terminal station.

According to the next invention, each of the interfering base stations determines an attenuation amount of transmission power according to the magnitude of a received power difference of each power difference class included in the transmission power suppress command targeted to the base station. Therefore, the attenuation amount of the transmission power is set small when the received power difference of a power difference class in the transmission power suppress command is small. Thus, it is possible to reduce degradation of the demodulation capability due to switching of a combined signal during movement of the terminal station. Further, when the received power difference of the power difference class is large, the attenuation amount of the transmission power is set large. Therefore, it is possible to reduce influence of an interference signal having a low likelihood of being used for diversity combining and enhance demodulation capability of the terminal station.

According to the next invention, each of the interfering base stations calculates a moving average value of attenuation amounts of transmission power determined by the transmission power suppress commands, and controls suppression of the transmission power based on the moving average value. Therefore, it is possible to reduce influence of instantaneous fluctuations in the received signal levels of the terminal station due to fading, and realize transmission power control capable of precisely compensating for influence of a propagation path loss between the terminal station and each base station.

According to the next invention, there is provided the low-pass filter, for removing a high frequency component from the signal instructing the attenuation amount of the transmission power, instead of the process of calculating the moving average value, and the influence of instantaneous fluctuations in the received signal is removed from the attenuation amount of the transmission power determined by the transmission power suppress command. Therefore, it is possible to realize transmission power control capable of precisely compensating for influence of a propagation path loss between the terminal station and each base station.

According to the next invention, each of the interfering base stations controls so as to decrease the attenuation amount of transmission power to allow the transmission power to approach the default value when the received power difference of the power difference class is smaller than the predetermined power-suppressed threshold value. The interfering base station also controls so as to increase the attenuation amount of transmission power to allow the transmission power of the interference signal to be suppressed when the received power difference of the power difference class is greater than the predetermined power-suppressed threshold value. Therefore, it is possible to reduce degradation of demodulation capability due to switching of the combined signal during movement of the terminal station, reduce influence of an interference signal having a low likelihood of being used for diversity combining, and enhance demodulation capability of the terminal station.

According to the next invention, when the received power difference of an interference signal is greater than the preset attenuation-instructed threshold value, the terminal station generates a transmission power suppress command. Each of the base stations stores the transmission power suppress commands transmitted from the terminal station within a predetermined time, and determines the attenuation amount of the transmission power according to the total number of the stored transmission power suppress commands. Therefore, it is possible to suppress the information amount of the transmission power suppress commands, reduce influence of an interference signal having a low likelihood of being used for diversity combining by simple transmission power control, and enhance demodulation capability of the terminal station.

According to the next invention, an information series having redundancy is employed as a transmission power suppress command transmitted from the terminal station to an interfering base station. Therefore, even if a transmission error occurs in the transmission power suppress command on a link, it is possible to accurately control the transmission power.

Industrial Applicability

As explained above, the wireless communication system according to the present invention is useful for a terminal station and a base station that employ the CDMA system to perform communications. Particularly, the wireless communication system is suitable for a mobile communication system that employs a “site diversity system” for improvement in received signal quality in the terminal station. In the site diversity system, the same data is transmitted from a plurality of base stations to one and the same terminal station, and the terminal station receives signals from the base stations and combines the received signals.

1-26 (Canceled).

27 A terminal station for performing wireless communications based on diversity combining with a plurality of base stations, comprising:
a plurality of received power measuring units each of which receives a radio signal transmitted by a corresponding one of the base stations and measures power of the radio signal;
a combined signal selecting unit that determines, based on the power of each of the radio signals, a predetermined number of radio signals that are to be employed in the diversity combining;
an interference signal suppression control unit that generates a transmission power suppress command for instructing suppression of transmission power according to a difference in the powers of a combined signal and an interference signal, the combined signal being the radio signal that is determined by the selecting unit to be employed in the diversity combining and the interference signal being the radio signal other than the combined signal; and
a transmission processing unit that identifies a base station that has transmitted the interference signal, modulates the transmission power suppress command, and transmits the modulated transmission power suppress command to the base station that has transmitted the interference signal.

28 The terminal station according to claim 27, wherein
the interference signal suppression control unit previously stores a plurality of threshold values, classifies the difference into a plurality of classes based on a comparison of the difference and the threshold values, and generates the transmission power suppress command that includes a specific information series for identifying the class of the difference.

29 The terminal station according to claim 27, wherein
the interference signal suppression control unit previously stores a threshold value and generates the transmission power suppress command when the difference is greater than or equal to the threshold value.

30 The terminal station according to claim 27, wherein
the interference signal suppression control unit generates the transmission power suppress command according to each of a difference in the powers of each of a plurality of combined signals and each of a plurality of interference signals, the combined signals being the radio signals that are determined by the selecting unit to be employed in the diversity combining and the interference signals being the radio signals other than the combined signals, and
the transmission processing unit identifies base stations that have transmitted corresponding ones of the interference signals, modulates the transmission power suppress command, and transmits the modulated transmission power suppress command to the base stations that have transmitted the interference signals.

31 A base station for performing wireless communications based on diversity combining with a terminal station, comprising:
a transmission power control unit that controls so as to suppress transmission power of a radio signal to be transmitted to the terminal station by a predetermined attenuation amount when a radio signal that includes a transmission power suppress command is received from the terminal station.

32 The base station according to claim 31, wherein the transmission power suppress command includes a specific information series for identifying a class of a difference in powers of a combined signal and an interference signal, and
the transmission power control unit determines the attenuation amount of the transmission power of the radio power to be transmitted to the terminal station based on the class.

33 The base station according to claim 32, wherein the transmission power control unit includes:
a memory unit that previously stores a threshold value;
a command analyzer that issues an attenuation instructing signal that instructs to decrease the attenuation amount when the class corresponds to a difference smaller than the threshold value and that instructs to increase the attenuation amount when the class corresponds to a difference greater than the threshold value; and
an attenuation amount determiner that calculates the attenuation amount of the transmission power of the radio signal to be transmitted to the terminal station based on a result of integration of the attenuation instructing signals over a predetermined period of time.

34 The base station according to claim 31, wherein the transmission power control unit further includes an averaging unit that sequentially receives the attenuation amounts calculated based on the transmission power suppress command and calculates a moving average of the attenuation amounts over a predetermined period of time, wherein
the transmission power control unit controls so as to suppress the transmission power of the radio signal to be transmitted to the terminal station based on the moving average of the attenuation amounts.

35 The base station according to claim 34, the transmission power control unit further including a low-pass filter, having a predetermined frequency characteristic, that sequentially receives the attenuation amounts calculated based on the transmission power suppress command and performs filtering of the attenuation amounts, wherein
the transmission power control unit controls so as to suppress the transmission power of the radio signal to be transmitted to the terminal station based on attenuation amounts obtained as a result of the filtering.

36 The base station according to claim 31, wherein the transmission power control unit further includes:
a command storage unit that stores transmission power suppress commands received during a predetermined period of time; and
an attenuation amount determiner that counts a number of the transmission power suppress commands stored in the command storage unit, and calculates the attenuation amount of the transmission power of the radio signal to be transmitted to the terminal station based on the count.

37 A terminal station for performing wireless communications based on diversity combining with a plurality of base stations, comprising:
a plurality of received power measuring units each of which receives a radio signal transmitted by a corresponding one of the base stations and measures a signal power-to-interference power ratio for a specific known series included in each of the radio signals;
a combined signal selecting unit that determines, based on the signal power-to-interference power ratio of each of the radio signals, a predetermined number of radio signals that are to be employed in the diversity combining; and
the interference signal suppression control unit that generates a transmission power suppress command for instructing suppression of transmission power according to a difference in the signal power-to-interference power ratios of a combined signal and an interference signal, the combined signal being the radio signal that is determined by the selecting unit to be employed in the diversity combining and the interference signal being the radio signal other than the combined signal; and
a transmission processing unit that identifies a base station that has transmitted the interference signal, modulates the transmission power suppress command, and transmits the modulated transmission power suppress command to the base station that has transmitted the interference signal.

38 A wireless communication system comprising a terminal station and a plurality of base stations that perform wireless communications based on diversity combining, wherein
the terminal station includes:
a plurality of received power measuring units each of which receives a radio signal transmitted by a corresponding one of the base stations and measures power of the radio signal;
a combined signal selecting unit that determines, based on the power of each of the radio signals, a predetermined number of radio signals that are to be employed in the diversity combining;
an interference signal suppression control unit that generates a transmission power suppress command for instructing suppression of transmission power according to a difference in the powers of a combined signal and an interference signal, the combined signal being the radio signal that is determined by the selecting unit to be employed in the diversity combining and the interference signal being the radio signal other than the combined signal; and
a transmission processing unit that identifies a base station that has transmitted the interference signal, modulates the transmission power suppress command, and transmits the modulated transmission power suppress command to the base station that has transmitted the interference signal; and
each of the base stations includes:
a transmission power control unit that controls so as to suppress transmission power of a radio signal to be transmitted to the terminal station by a predetermined attenuation amount when a radio signal that includes a transmission power suppress command is received from the terminal station.

39 The wireless communication system according to claim 38, wherein
the interference signal suppression control unit previously stores a plurality of threshold values, classifies the difference into a plurality of classes based on a comparison of the difference and the threshold values, and generates the transmission power suppress command that includes a specific information series for identifying the class of the difference.

40 The wireless communication system according to claim 38, wherein
the interference signal suppression control unit of the terminal station generates the transmission power suppress command according to each of a difference in the powers of each of a plurality of combined signals and each of a plurality of interference signals, the combined signals being the radio signals that are determined by the selecting unit to be employed in the diversity combining and the interference signals being the radio signals other than the combined signals, and
the transmission processing unit of the terminal station identifies base stations that have transmitted corresponding ones of the interference signals, modulates the transmission power suppress command, and transmits the modulated transmission power suppress command to the base stations that have transmitted the interference signals.

41 The wireless communication system according to claim 38, wherein the transmission power suppress command includes a specific information series for identifying a class of a difference in powers of a combined signal and an interference signal, and
the transmission power control unit of the base stations determines the attenuation amount of the transmission power of the radio power to be transmitted to the terminal station based on the class.

42 The wireless communication system according to claim 41, wherein the transmission power control unit includes:
a memory unit that previously stores a threshold value;
a command analyzer that issues an attenuation instructing signal that instructs to decrease the attenuation amount when the class corresponds to a difference smaller than the threshold value and that instructs to increase the attenuation amount when the class corresponds to a difference greater than the threshold value; and
an attenuation amount determiner that calculates the attenuation amount of the transmission power of the radio signal to be transmitted to the terminal station based on a result of integration of the attenuation instructing signals over a predetermined period of time.

43 The wireless communication system according to claim 38, wherein the transmission power control unit further includes an averaging unit that sequentially receives the attenuation amounts calculated based on the transmission power suppress command and calculates a moving average of the attenuation amounts over a predetermined period of time, wherein
the transmission power control unit controls so as to suppress the transmission power of the radio signal to be transmitted to the terminal station based on the moving average of the attenuation amounts.

44 The wireless communication system according to claim 43, the transmission power control unit further including a low-pass filter, having a predetermined frequency characteristic, that sequentially receives the attenuation amounts calculated based on the transmission power suppress command and performs filtering of the attenuation amounts, wherein
the transmission power control unit controls so as to suppress the transmission power of the radio signal to be transmitted to the terminal station based on attenuation amounts obtained as a result of the filtering.

45 The wireless communication system according to claim 38, wherein
the interference signal suppression control unit in the terminal station generates a specific information series having redundancy as the transmission power suppress command, and
the transmission power control unit in each of the base stations previously stores the specific information series that has a likelihood of being transmitted from the terminal station, and calculates a correlation value between an information series actually transmitted from the terminal station and the information series that is previously stored to specify an information series with a maximum likelihood as the transmission power suppress command, based on the correlation value.

46 The wireless communication system according to claim 38, wherein
the interference signal suppression control unit of the terminal station previously stores a threshold value and generates the transmission power suppress command when the difference is greater than or equal to the threshold value, and
the transmission power control unit of the base stations includes:
a command storage unit that stores transmission power suppress commands received during a predetermined period of time; and
an attenuation amount determiner that counts a number of the transmission power suppress commands stored in the command storage unit, and calculates the attenuation amount of the transmission power of the radio signal to be transmitted to the terminal station based on the count.

47 The wireless communication system according to claim 46, wherein
the interference signal suppression control unit generates the transmission power suppress command according to each of a difference in the powers of each of a plurality of combined signals and each of a plurality of interference signals, the combined signals being the radio signals that are determined by the selecting unit to be employed in the diversity combining and the interference signals being the radio signals other than the combined signals, and
the transmission processing unit identifies base stations that have transmitted corresponding one of the interference signals, modulates the transmission power suppress command, and transmits the modulated transmission power suppress command to the base stations that have transmitted the interference signals.

48 A wireless communication system comprising a terminal station and a plurality of base stations that perform wireless communications based on diversity combining, wherein
the terminal station includes:
a received power measuring unit each of which receives a radio signal transmitted by a corresponding one of the base stations and measures a signal power-to-interference power ratio for a specific known series included in each of the radio signals;
a combined signal selecting unit that determines, based on the signal power-to-interference power ratio of each of the radio signals, a predetermined number of radio signals that are to be employed in the diversity combining; and
the interference signal suppression control unit that generates a transmission power suppress command for instructing suppression of transmission power according to a difference in the signal power-to-interference power ratios of a combined signal and an interference signal, the combined signal being the radio signal that is determined by the selecting unit to be employed in the diversity combining and the interference signal being the radio signal other than the combined signal; and
a transmission processing unit that identifies a base station that has transmitted the interference signal, modulates the transmission power suppress command, and transmits the modulated transmission power suppress command to the base station that has transmitted the interference signal; and
each of the base stations includes:
a transmission power control unit that controls so as to suppress transmission power of a radio signal to be transmitted to the terminal station by a predetermined attenuation amount when a radio signal that includes a transmission power suppress command is received from the terminal station.

49 A method of controlling transmission power to be used in a wireless communication system in which a terminal station performs wireless communications based on diversity combining with a plurality of base stations, comprising:
the terminal station receiving a radio signal transmitted by a corresponding one of the base stations;
the terminal station measuring power of each of the radio signals received;
the terminal station determining, based on the power of each of the radio signals, a predetermined number of radio signals that are to be employed in the diversity combining;
the terminal station generating a transmission power suppress command for instructing suppression of transmission power according to a difference in the powers of a combined signal and an interference signal, the combined signal being the radio signal that is determined by the selecting unit to be employed in the diversity combining and the interference signal being the radio signal other than the combined signal; and
the terminal station identifying a base station that has transmitted the interference signal, modulating the transmission power suppress command, and transmitting the modulated transmission power suppress command to the base station that has transmitted the interference signal; and
each of the base stations controlling so as to suppress transmission power of a radio signal to be transmitted to the terminal station by a predetermined attenuation amount when a radio signal that includes a transmission power suppress command is received from the terminal station.

50 The method according to claim 49, wherein
the generating includes previously storing a plurality of threshold values, classifying the difference into a plurality of classes based on a comparison of the difference and the threshold values, and generating the transmission power suppress command that includes a specific information series for identifying the class of the difference, and
the controlling includes determining the attenuation amount of the transmission power of the radio power to be transmitted to the terminal station based on the class.

51 The method according to claim 50, wherein the controlling includes:
issuing an attenuation instructing signal that instructs to decrease the attenuation amount when the class corresponds to a difference smaller than a predetermined threshold value and that instructs to increase the attenuation amount when the class corresponds to a difference greater than the threshold value; and
calculating the attenuation amount of the transmission power of the radio signal to be transmitted to the terminal station based on a result of integration of the attenuation instructing signals over a predetermined period of time.

52 The transmission power control method according to claim 49, wherein
the generating includes generating the transmission power suppress command when the difference is greater than or equal to a predetermined threshold value, and
the controlling includes:
storing transmission power suppress commands received during a predetermined period of time;
counting number of the transmission power suppress commands stored; and
calculating the attenuation amount of the transmission power of the radio signal to be transmitted to the terminal station based on the count.
